(19) United States
(12) Patent Application Publication
(10) Pub. No.: US 2017/0335622 A1
(43) Pub. Date: Nov. 23, 2017

(54) Lift Gate Protector

(71) Applicant: James Frederick Nemeth, Northampton, PA (US)

(72) Inventor: James Frederick Nemeth, Northampton, PA (US)

(21) Appl. No.: 15/156,368

(22) Filed: May 17, 2016

(51) Int. Cl. E06B 7/28; F16F 7/00; E06B 3/70

(52) U.S. Cl. CPC E06B 7/28; F16F 7/00; E05Y 2900/106; E06B 2003/7044

(57) ABSTRACT

The present invention is a lift gate protector that is placed on a garage door to protect a lift gate of a vehicle. The gate protector is made of an impact material such as foam and is attached to a garage door to protect a lift gate from being damaged when opened. It is positioned at the location on the garage door that the provides the maximum protection for a vehicle's lift gate.

### CROSS-REFERENCES TO RELATED APPLICATIONS (IF ANY)

None

### BACKGROUND

### 1. Field of the Invention

The present invention relates to a life gate protector which will protect a lift gate from damage.

### 2. Description of Prior Art

There is a need for saving a the car or vehicle from dents, scraps, and other punctures. The costs to repair this issue could become quite expensive, possibly reaching into the thousands of dollars if the whole lift gate needs to be replaced. In the analysis of a pricing point, this would be the most valued and usable data point as it provides a tangible pricing point.

The average cost to fix a simple ding or dent on a car door is at least $75 up to $159. This is the average price for a car door not a lift gate on a SUV or minivan. The price could be much higher for these larger doors, well into the hundreds of the dollar for the fix.

Anyone who owns a car with a remote lift gate, eventually comes into this problem. Someone accidentally pushes/hits the hatch button on your car key fob when retrieving your keys while the car is in your garage. The lift gate goes up inside your closed garage. The lift gate then opens and hits the metal hinge on the closed garage door. This is the sharp metal hinge holding the garage door panels together. Next thing you know one of your most valued assets, your car, gets a large dent with the paint scraped. This happens multiple times over the many years that you own the car.

There is still room for improvement in the art.

### SUMMARY OF THE INVENTION

The present invention is a lift gate protector can be placed on a garage door to protect a lift gate of a vehicle. The gate protector is made of an impact material such as foam. The gate protector is attached to a garage door. It is positioned at the location the provides the maximum protection for a vehicle's lift gate.

The lift gate can have a vinyl covering. It can be attached to the garage door frame. It can be attached by bar slit that attaches to a cross frame bar or it can contain magnets or screws.

The current invention is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows the lift protector on a garage door;

FIG. 2 shows different views of a lift protector;

FIG. 3 displays different shapes of the lift protectors;

FIG. 4 displays different lift protectors with a magnets; and

FIG. 5 shows a car with the lift protector.

### DESCRIPTION OF THE PREFERRED EMBODIMENT

There are a number of significant design features and improvements incorporated within the invention.

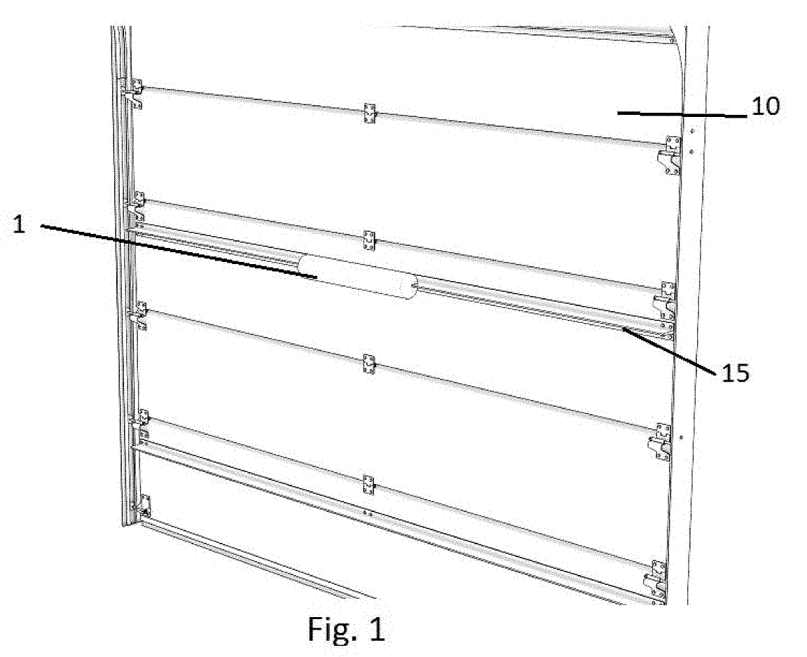

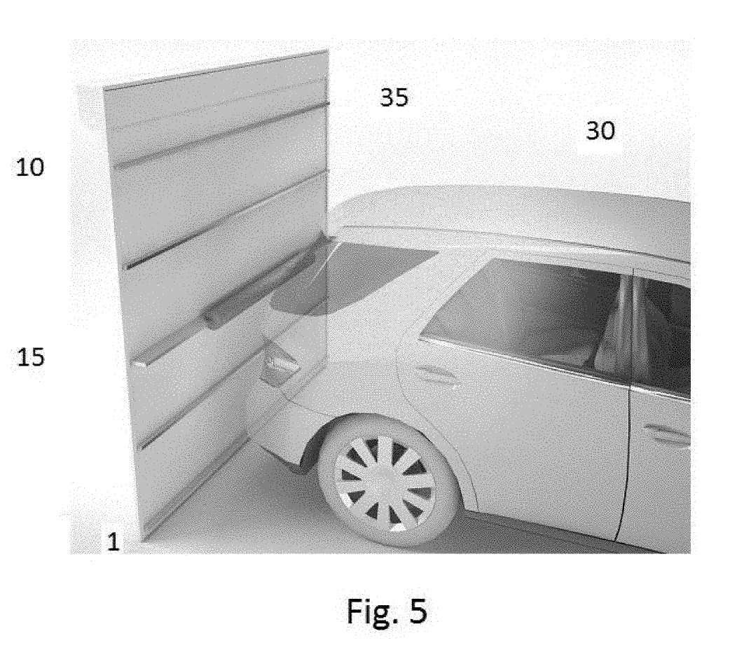

The present invention is a lift gate protector 1. As shown in FIG. 1, the lift gate protector 1 is placed on a garage door 10 to protect a lift gate 35 of a vehicle 30. The lift gate protector 1 protects the lift gate 35 from damage from hitting the gate 35 against the garage door 10 by opening it into it or by backing into it as shown in FIG. 5.

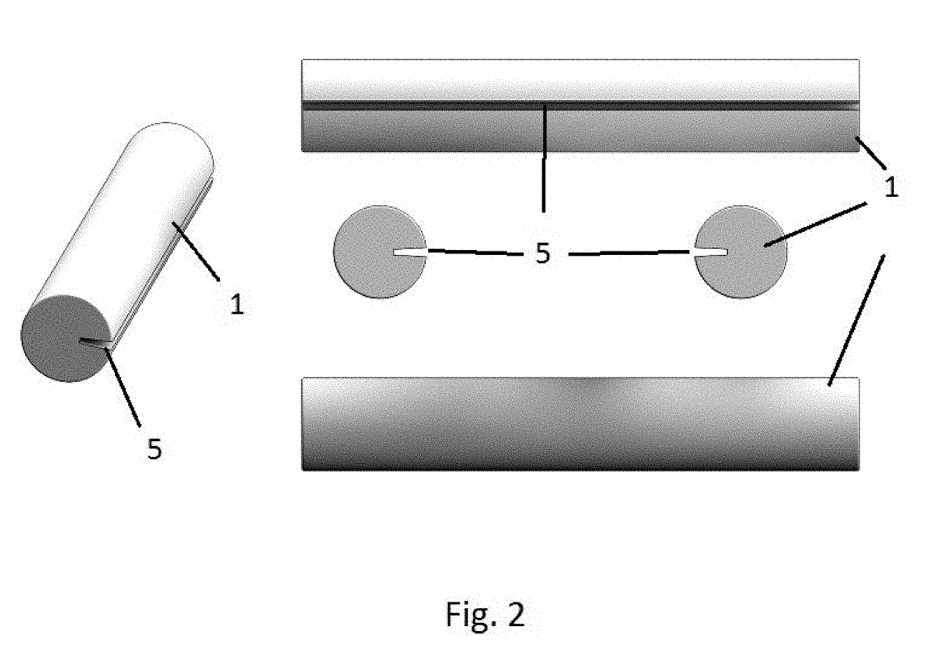

The gate protector 1 is made of an impact material such as foam. The gate protector 1 is attached to a garage door 10. It is positioned at the location the provides the maximum protection for a vehicle's lift gate 35. One design is shown in FIG. 2. It is a rounded design with a bar slit 5 that runs the length of the gate protector 1. The bar slit 5 is designed to fit onto the frame of the garage door 10 on one of the bars 15. The bar slit 5 width depends on the width of the bar 15 that the gate protector 1 is place on to.

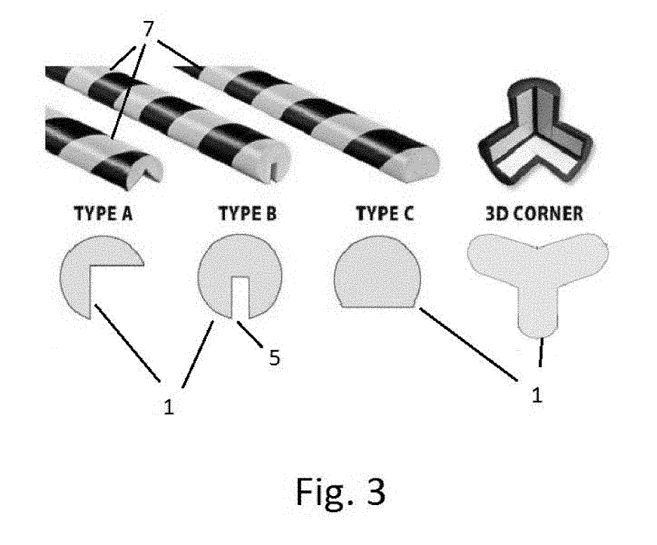

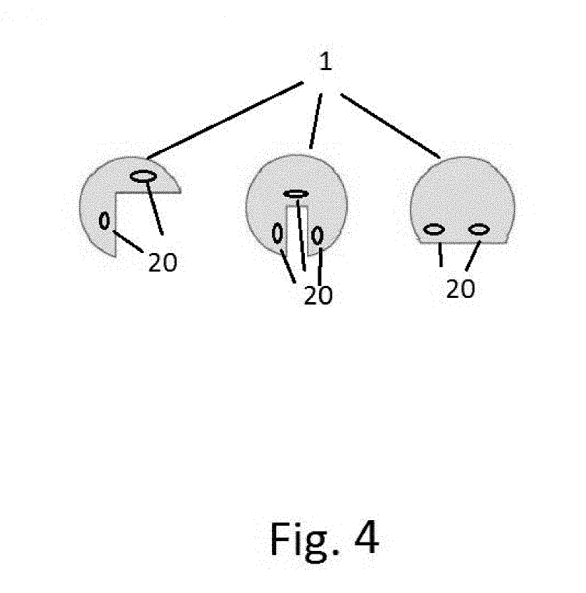

As shown in FIG. 3, the lift gate 1 can have a vinyl covering 7. The covering 7 adds to the protection as it is a softer surface and less likely to scratch the door lift 35. FIG. 3 also shows an elevated and crosscut view of different designs of the gate protector 1. Type A has a 90 degree opening that would fit on to larger frames or bars. Type B, as already disclosed, has a bar slit 5 that fits onto a bar 15 of the frame of a garage door 10. Type C has one flat side 6 which is designed to fit onto a flat surface such as when a garage door 10 does not have any bars 15 for the lift protector 1 to attached to and can be attached through screws, magnets 20 or adhesive including adhesive tape. The magnets 20 can be embedded within the protector 1 or attached to its surface as shown in FIG. 4. The lift gate protector 1 can even be designed as a 3D corner to be placed in corners.

As shown in FIG. 3, the lift gate protector 1 can have a warning sign design on its outer surface. This will allow a person to see it easier. It can even be in any color including bright and florescent colors, any design or even glow in dark.

The lift gate protector 1 can be attached to the garage door frame. It can be attached by a slit 5 that attaches to a cross frame or it can contain magnets or screws to be attached. FIG. 4 shows a lift gate protector 1 with neodymium magnets 20 to not only attach to bars 15 on a garage door 10, but also garage doors without bars 15. The magnets 20 are used to secure to the garage door hinges should the hinge be in line with the lift gate opening. The lift gate protector 1 could adhere via an adhesive such as a strong double side adhesive strips. The magnetic option allows for more versatility in attaching and repositioning.

### Operation

The gate protector 1 would be place on the garage door 10 or another surface that a user would have to have lift gate protection for. The gate protector 1 can be placed on a bar 15 of the garage door 10 if a bar 15 is available or it can be attached by an attachment means such as magnets, screws or adhesives. The gate protector 1 can be made as a fixed length or cut to a desired length to properly fit the door 10 or location.

### Advantages

The current invention protects a cars from damage. The current invention is the best solution for making sure that your cars never get dinged or damaged again from your garage door.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device to protect lift gates comprising:
a protector made of an impact material attached to a surface.

2. A device according to claim 1 further comprising said surface being a garage door.

3. A device according to claim 1 further comprising where said protector has a bar slit that runs the length of it.

4. A device according to claim 3 further comprising where said bar slit is place on a bar within a garage door.

5. A device according to claim 1 further comprising where said protector is covered in vinyl.

6. A device according to claim 1 further comprising where said protector has a warning sign design on its outer surface.

7. A device according to claim 1 further comprising where said protector is a bright color.

8. A device according to claim 1 further comprising where said protector is a florescent color.

9. A device according to claim 1 further comprising where said protector is a glow in dark.

10. A device according to claim 1 further comprising where said protector is cylindrical in shape.

11. A device according to claim 1 further comprising where said protector is cylindrical in shape.

12. A device according to claim 3 further comprising where said protector is cylindrical in shape with a bar slit the runs perpendicular along the protector's length.

13. A device according to claim 3 further comprising where said protector has magnets.

14. A device according to claim 1 further comprising where said protector is cylindrical with a flat side.

15. A device according to claim 14 further comprising where said a flat side is attached to a garage door.

16. A device according to claim 15 further comprising where said a flat side is attached to a garage door using an adhesive.

17. A device according to claim 15 further comprising where said a flat side is attached to a garage door using magnets.

18. A device according to claim 1 further comprising where said protector is cylindrical with a open side where the open side is form of two flat surfaces that are ninety degrees from each other.

19. A device according to claim 18 further comprising where magnets are place along the two flat surfaces.

20. A device according to claim 1 further comprising having the protector in the shape of a 3D corner.
